(19) United States
(12) Patent Application Publication
(10) Pub. No.: US 2022/0155769 A1
(43) Pub. Date: May 19, 2022

(54) APPLIANCE OPERATION AND DIAGNOSTICS USING COMBINED MATRICES

(71) Applicant: Haier US Appliance Solutions, Inc., Wilmington, DE (US)

(72) Inventor: Wei Zhou, Louisville, KY (US)

(21) Appl. No.: 16/952,666

(22) Filed: Nov. 19, 2020

(51) Int. Cl. G05B 23/02; G06N 20/00; H04M 15/00; G06F 17/16

(52) U.S. Cl. CPC G05B 23/0243; G05B 23/0281; G05B 23/0283; H04M 15/00; G06F 17/16; G06N 20/00

(57) ABSTRACT

A method of operating a domestic appliance or electronic assembly may include receiving one or more component input signals vectors of the electronic assembly. The method may also include generating a plurality of discrete signal matrices based on the one or more input signals. The method may further include joining the plurality of discrete signal matrices together as a combined matrix. The method may still further include analyzing the combined matrix for appliance performance.

### FIELD OF THE INVENTION

The present subject matter relates generally to electronic assemblies, such as domestic appliances, and more particularly to methods of operating the same using multiple combined matrices.

### BACKGROUND OF THE INVENTION

Generally, modern domestic appliances (e.g., refrigerator appliances, oven appliances, dishwasher appliances, washing machine appliances, dryer appliances, microwave appliances, air conditioning appliances, etc.) are made up of multiple components that include or monitored by one or more electronic assemblies (e.g., an assembly or subsystem formed from one or more electrically driven or signal-generating components). For instance, in the case of a refrigerator appliance, a sealed cooling system having a compressor, evaporator, condenser, and expansion device is often provided. The compressor is selectively activated by a controller (e.g., to motivate refrigerant through the sealed cooling system) and one or more electronic sensors can be mounted throughout the appliance to monitor the status or performance of the evaporator, condenser, expansion device, or compressor. Additional electronic components or sensors can be provided at other portions of the refrigerator appliance (e.g., at or within a freezer chamber, refrigerator chamber, door gasket, defrost heating element, etc.) to further direct or monitor performance of the refrigerator appliance.

Although many of these electronic assemblies direct or relate to different functions of the appliance, they may influence or affect performance of other assemblies or overall performance of the appliance in ways that are difficult to predict or identify. For instance, poor performance at a compressor may affect cooling issues at both a freezer chamber and a fresh food chamber, but that poor performance may only be manifested (or indicated at) the fresh food chamber. Existing methods for monitoring performance or diagnosing problems of an appliance are typically limited to recording and evaluating signals from individual components or assemblies. For instance, operation and sensory data for each component may be independently recorded and evaluated for each cycle. This data is typically unstructured and must be evaluated in isolation. Thus, it is difficult (e.g., time consuming, processing intensive, inefficient, or inaccurate) to discern how one component or assembly might affect another. This remains true even if existing machine learning techniques are applied to the operation and sensory data. Moreover, existing techniques are only able to evaluate the unstructured appliance data for one condition (e.g., detecting an anomaly or failure of a single component, such as a compressor) at a time. Multiple discrete algorithms requiring significant computing time or power are thus required for evaluating multiple aspects or conditions of an appliance. Furthermore, it can be difficult to actually track performance over the course of several cycles, let alone over several days or weeks.

Additionally or alternatively, although many appliance models have similar or overlapping components (e.g., a compressor, evaporator, condenser, and expansion device), which may thus be impacted in similar ways, the manner in which data is structured makes it virtually impossible to use data from one appliance model to evaluate performance of another appliance model. This is generally true both for appliance models made by different manufacturers as well as different appliance models made by the same manufacturer.

As a result, it would be useful to provide a method of operating a domestic appliance or electronic assembly that address one or more of the above issues. In particular, a method of operating a domestic appliance or electronic assembly that improves data handling would be advantageous. Additionally or alternatively, a method of operating a domestic appliance or electronic assembly that permits multiples components or assemblies to be efficiently evaluated in tandem or over time would be advantageous. Also additionally or alternatively, a method of operating a domestic appliance or electronic assembly that permits multiple conditions to be evaluated (e.g., tested for) simultaneously would be advantageous. Further additionally or alternatively, a method of operating a domestic appliance or electronic assembly that can be used with multiple discrete appliance models would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a domestic appliance is provided. The method may include receiving a plurality of first component signals from a first component over a plurality of discrete cycles and generating a first signal matrix based on the received plurality of first component signals. The method may also include receiving a plurality of second component signals from a second component over the plurality of discrete cycles and generating a second signal matrix based on the received plurality of second component signals. The method may further include joining the first signal matrix and the second signal matrix together as a combined matrix and analyzing the combined matrix for appliance performance.

In another exemplary aspect of the present disclosure, a method of operating a domestic appliance is provided. The method may include receiving a plurality of first component signals from a first component over a plurality of discrete cycles and generating a first signal matrix based on the received plurality of first component signals. Generating the first signal matrix may include assembling the received first component signals as a vector, calculating a first set of result values of a first predetermined matrix function using the vector, and assembling the first set of result values in the first signal matrix as a recursive matrix comprising recursive entries of result values of the first set for each cycle of the plurality of discrete cycles. The method may also include generating a second signal matrix based on the received plurality of first component signals. Generating the second signal matrix may include calculating a second set of result values of a second predetermined matrix function using the vector and assembling the second set of result values in the second signal matrix as a recursive matrix comprising recursive entries of result values of the second set for each cycle of the plurality of discrete cycles. The method may further include joining the first signal matrix and the second signal matrix together as a combined matrix and analyzing the combined matrix for appliance performance.

In yet another exemplary aspect of the present disclosure, a method of operating an electronic assembly is provided. The method may include receiving one or more component input signals vectors of the electronic assembly. The method may also include generating a plurality of discrete signal matrices based on the one or more input signals. The method may further include joining the plurality of discrete signal matrices together as a combined matrix. The method may still further include analyzing the combined matrix for appliance performance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a domestic appliance according to exemplary embodiments of the present disclosure.

FIG. 2 provides a front elevation view of a domestic appliance according to exemplary embodiments of the present disclosure, wherein refrigerator doors are shown in an open position.

FIG. 3 provides a schematic view of system, including a domestic appliance, according to exemplary embodiments of the present disclosure.

FIG. 4 provides another schematic view of a domestic appliance according to exemplary embodiments of the present disclosure.

FIG. 5 provides a depiction of an example sensor signal matrix generated from an independent cycle sensor signal vector according to exemplary embodiments of the present disclosure.

FIG. 6 provides a depiction of multiple matrices corresponding to discrete subsystems of a domestic appliance according to exemplary embodiments of the present disclosure.

FIG. 7 provides a depiction of an example combination of matrices according to exemplary embodiments of the present disclosure.

FIG. 8 provides a depiction of an example machine-learned model according to exemplary embodiments of the present disclosure.

FIG. 9 provides a flow chart illustrating a method of operating an electronic assembly according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

Generally, the present disclosure relates to methods of operating a domestic appliance or electronic assembly having multiple electronic components or sensors that can generate data during use. The data generated by one or more components may be received, recorded, and organized together as single combined matrix. The combined matrix may be analyzed (e.g., using a machine-learned model) to efficiently measure overall performance and look for multiple different issues at the same time.

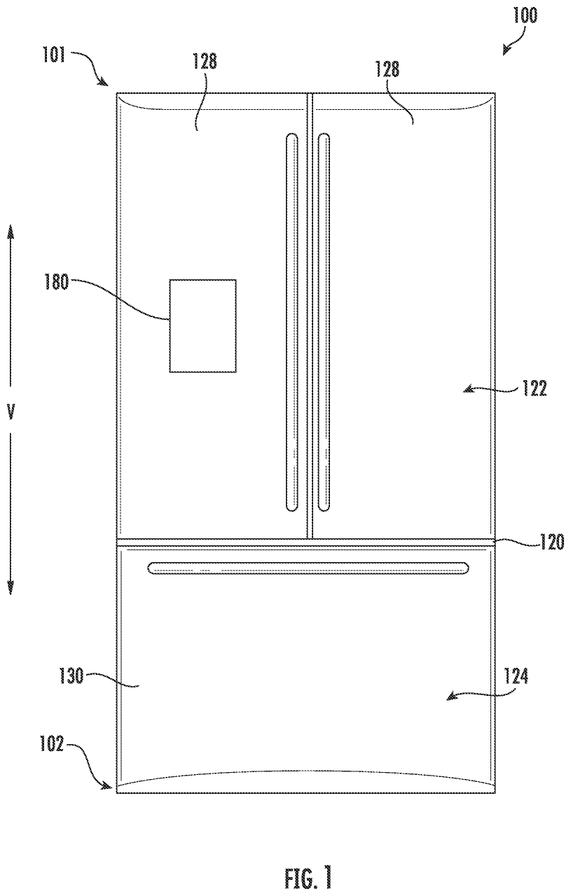

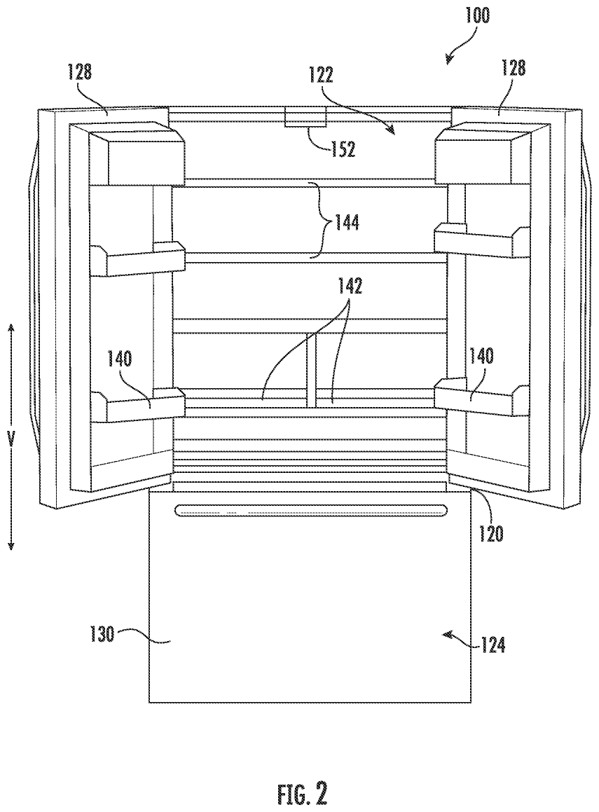

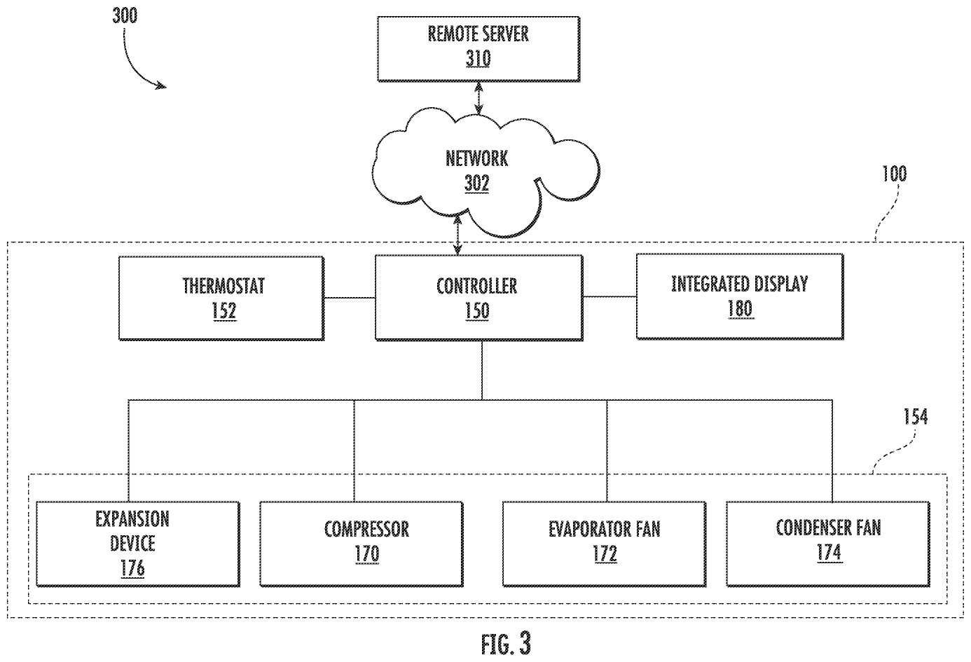

Turning now to the figures, FIG. 1 provides a front elevation view of an exemplary domestic appliance 100. In particular, FIG. 1 illustrates a domestic appliance 100 that is a refrigerator appliance with refrigerator doors 128 shown in a closed position. FIG. 2 provides a front view elevation of domestic appliance 100 with refrigerator doors 128 shown in an open position to reveal a fresh food chamber 122 of domestic appliance 100. FIG. 3 provides a schematic view of a system 300 that includes domestic appliance 100, including at least a portion of the electronic components of domestic appliance 100 in communication with a remote server 310.

Domestic appliance 100 includes a cabinet or housing 120 that extends between a top 101 and a bottom 102 along a vertical direction V. Housing 120 defines chilled chambers for receipt of food items for storage. In particular, housing 120 defines fresh food chamber 122 positioned at or adjacent top 101 of housing 120 and a freezer chamber 124 arranged at or adjacent bottom 102 of housing 120. As such, domestic appliance 100 is generally referred to as a bottom mount refrigerator.

Although domestic appliance 100 is shown as a refrigerator appliance in FIGS. 1 and 2, it is recognized that the benefits of the present disclosure apply to other types and styles of domestic appliance 100s or electronic assemblies having multiple electronic components (e.g., assemblies or subsystems formed from one or more electrically driven or signal-generating components that can exchange data signals with a computing device or processor, including memory devices therefor). For instance, the present disclosure is understood to apply to oven appliances, dishwasher appliances, washing machine appliances, dryer appliances, microwave appliances, air conditioning appliances, etc. Consequently, the description set forth herein is for illustrative purposes only and is not intended to be limiting in any aspect to any particular configuration or appliance.

As shown, refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. As discussed above, refrigerator doors 128 and freezer door 130 are shown in the closed configuration in FIG. 1, and refrigerator doors 128 are shown in the open position in FIG. 2.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted within fresh food chamber 122. Bins 140, drawers 142, and shelves 144 are configured for receipt of stored items (e.g., beverages or solid food items) and may assist with organizing such food items. As an example, drawers 142 can receive fresh food items (e.g., vegetables, fruits, or cheeses) and increase the useful life of such fresh food items.

Domestic appliance 100 includes a controller 150 that is operatively coupled or in communication (e.g., electric or wireless communication) with various components of appliance 100. Controller 150 may include one or more processors and one or more memory devices (i.e., memory). The one or more processors can be any suitable processing device (e.g., a processor core, a microprocessor, a CPU, an ASIC, a FPGA, a microcontroller, etc.) and can be one processor or a plurality of processors that are operatively connected. The memory device can include one or more non-transitory computer-readable storage mediums, such as RAM, DRAM, ROM, EEPROM, EPROM, flash memory devices, magnetic disks, etc., or combinations thereof. The memory device may be a separate component from the processor or may be included onboard within the processor.

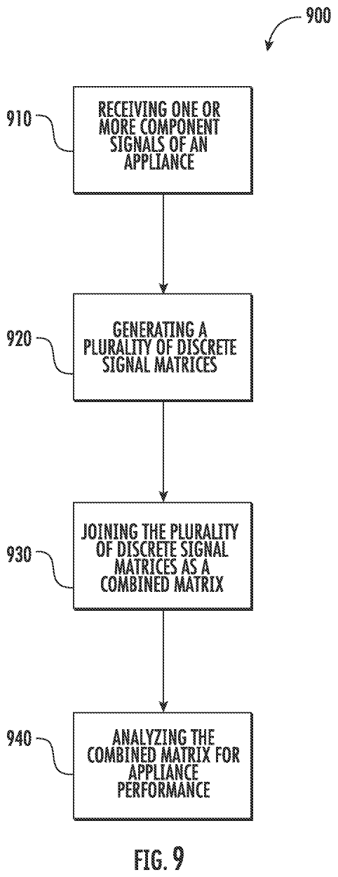

Generally, the memory devices can store data and instructions (e.g., on-transitory programming instructions) that are executed by the processors to cause domestic appliance 100 to perform operations. In certain embodiments, the instructions include a software package configured to operate appliance 100 or execute an operation routine (e.g., the exemplary method 900 described below with reference to FIG. 9). Additionally or alternatively, memory can store data that can be obtained (e.g., received, accessed, written, manipulated, generated, created, stored, etc.) for further analysis of appliance performance, such as data received from the electronic components, sensor data, processed sensor data, input data, output data, data indicative of machine-learned model(s) or other data/information described herein.

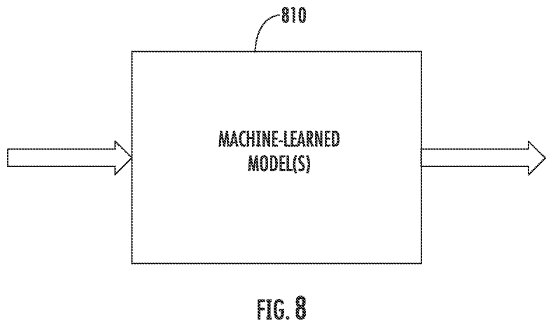

In some embodiments, controller 150 can store or include one or more machine-learned models 810 (FIG. 8). As examples, the machine-learned model(s) 810 (FIG. 8) can be or can otherwise include various machine-learned models such as, for example, neural networks (e.g., deep neural networks, etc.), support vector machines, decision trees, ensemble models, k-nearest neighbors models, Bayesian networks, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks.

Controller 150 may be positioned in a variety of locations throughout domestic appliance 100. Input/output (“I/O”) signals may be routed between controller 150 and various operational components of domestic appliance 100. One or more components of domestic appliance 100 may be in operative communication (e.g., electric communication) with controller 150 via one or more conductive signal lines or shared communication busses. Additionally or alternatively, one or more components of domestic appliance 100 may be in operative communication (e.g., wireless communication) with controller 150 via one or more wireless signal bands.

In certain embodiments, controller 150 is in operative communication with one or more components of a refrigeration system 154 of domestic appliance 100. Generally, refrigeration system 154 is charged with a refrigerant that is flowed through various components and facilitates cooling of the fresh food compartment 122 and the freezer compartment 124. Refrigeration system 154 may be charged or filled with any suitable refrigerant. For example, refrigeration system 154 may be charged with a flammable refrigerant, such as R441A, R600a, isobutene, isobutane, etc. As is understood, the refrigeration system 154 includes a compressor 170, a condenser 184, an evaporator 182, and an expansion device 176 (e.g., electronic expansion valve, thermal expansion valve, capillary tube, etc.) in fluid communication to direct the charged refrigerant therethrough. In some embodiments, refrigeration system 154 may be monitored separately as a condensing subsystem 156 (e.g., first subsystem or subsystem A) and cooling subsystem 158 (e.g., second subsystem or subsystem B). Condensing subsystem 156 includes one or more components (e.g., components A1 and A2), which may include compressor 170, expansion device 176, or a condenser fan 174 along with one or more sensors in operative communication with controller 150. Cooling subsystem 158 includes one or more components (e.g., components B1 and B2), which may include an evaporator fan 172, an evaporator 182 sensor (e.g., temperature sensor), or a defrost heater 186 along with one or more additional sensors in operative communication with controller 150. Controller 150 can selectively operate such components of condensing subsystem 156 and cooling subsystem 158 in order to cool fresh food chamber 122 or freezer chamber 124. In some embodiments, controller 150 is also in communication with one or more thermostats 152 (e.g., a thermocouple or thermistor) that may be mounted in fresh food compartment 122 or freezer compartment 124 (FIG. 2). Controller 150 may receive a signal from the thermostat that corresponds to a temperature of fresh food compartment 122 or freezer compartment 124. Controller 150 may also include an internal timer for calculating elapsed time periods.

In certain embodiments, domestic appliance 100 includes a control panel or integrated display 180. Integrated display 180 may be mounted on refrigerator door 128 (FIG. 1) or at any other suitable location on domestic appliance 100. Integrated display 180 is in operative communication with controller 150 such that integrated display 180 may receive or transmit one or more signals from/to controller 150. Integrated display 180 may include, for example, a liquid crystal display panel (LCD), a plasma display panel (PDP), or any other suitable mechanism for displaying an image (e.g., a projector). Additionally or alternatively, integrated display 180 may provide an interface (e.g., tactile inputs, such as buttons, or touch sensors overlaid across a graphical user interface) for selecting or controlling one or more functions of domestic appliance 100, as is generally understood.

As would be understood, various other components (e.g., an icemaker, dispenser, camera, etc.) may further be provided in operative communication with controller 150 as part of domestic appliance 100.

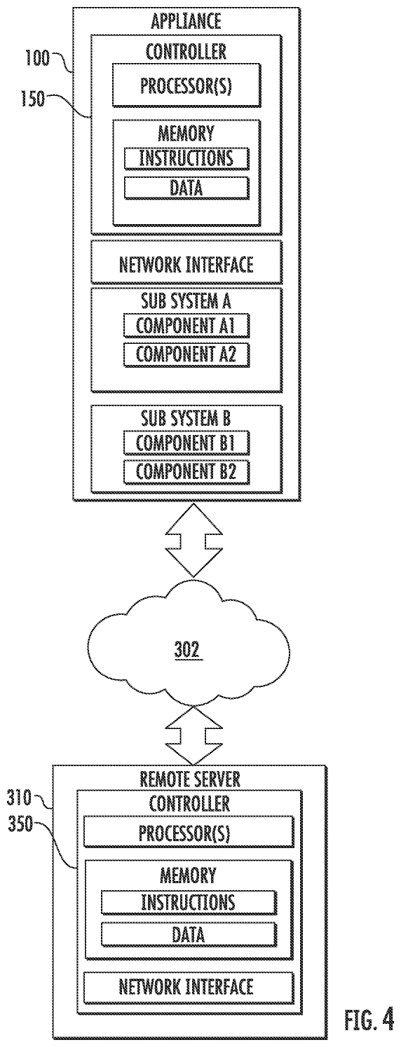

Turning especially to FIG. 4, in additional or alternative embodiments, domestic appliance 100 includes a network interface that couples domestic appliance 100 (e.g., controller 150) to a network 302 such that domestic appliance 100 can transmit and receive information over network 302. Network 302 can be any wired or wireless network such as a WAN, LAN, or HAN.

In some embodiments, controller 150 includes a network interface such that oven appliance 10 can connect to and communicate over one or more networks (e.g., network 302) with one or more network nodes. Network interface can be an onboard component of controller 150 or it can be a separate, off board component. Controller 150 can also include one or more transmitting, receiving, or transceiving components for transmitting/receiving communications with other devices communicatively coupled with domestic appliance 100. Additionally or alternatively, one or more transmitting, receiving, or transceiving components can be located off board controller 150.

Network 302 can be any suitable type of network, such as a local area network (e.g., intranet), wide area network (e.g., internet), low power wireless networks [e.g., Bluetooth Low Energy (BLE)], radio field wireless networks [e.g., Near Field Communications (NFC) pairing], cellular communications network, or some combination thereof and can include any number of wired or wireless links. In general, communication over network 302 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, the one or more remote servers 310 (e.g., web servers) are in operable communication with domestic appliance 100. The remote server(s) 310 can be used to host a service platform or cloud-based application. Additionally or alternatively, remote server(s) 310 can be used to host an information database (e.g., a machine-learned model, received data, or other relevant service data—optionally including intermediate processing data products). Remote server(s) 310 can be implemented using any suitable computing device(s). Each remote server 310 generally includes a remote controller 350 having one or more processors and one or more memory devices (i.e., memory). The one or more processors can be any suitable processing device (e.g., a processor core, a microprocessor, a CPU, an ASIC, a FPGA, a microcontroller, etc.) and can be one processor or a plurality of processors that are operatively connected. The memory device can include one or more non-transitory computer-readable storage mediums, such as RAM, DRAM, ROM, EEPROM, EPROM, flash memory devices, magnetic disks, etc., or combinations thereof. The memory devices can store data and instructions (e.g., on-transitory programming instructions) that are executed by the processors to cause remote server 310 to perform operations. For example, instructions could be instructions for receiving/transmitting component signals (e.g., including data or information), data vectors of appliance performance, data matrices of appliance performance, analyzation results, machine-learned models, etc.

The memory devices may also include data, such as data matrices of appliance performance, analyzation results, machine-learned models, etc., that can be retrieved, manipulated, created, or stored by processors. The data can be stored in one or more databases. The one or more databases can be connected to remote server 310 by a high bandwidth LAN or WAN, or through one or more secondary networks. Optionally, the one or more databases can be split up so that they are located in multiple locales.

Additionally or alternatively, memory can store data that can be obtained (e.g., received, accessed, written, manipulated, generated, created, stored, etc.) for further analysis of appliance performance, such as data received from the electronic components, sensor data, processed sensor data, input data, output data, data indicative of machine-learned model(s) or other data/information described herein.

In some embodiments, remote controller 350 can store or include one or more machine-learned models 810 (FIG. 8) (e.g., separate from or in addition to machine-learned models stored with controller 150). As examples, the machine-learned model(s) 810 (FIG. 8) can be or can otherwise include various machine-learned models such as, for example, neural networks (e.g., deep neural networks, etc.), support vector machines, decision trees, ensemble models, k-nearest neighbors models, Bayesian networks, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks. The machine-learned models of the remote server 310 may be used by the domestic appliance 100 (e.g., by transmitting such models directly to the domestic appliance 100 or by exchanging data signals, vectors, or matrices according to a client-server relationship). Additionally or alternatively, remote server 310 can train the machine-learned models through use of a model trainer (e.g., training algorithm), as would be understood. Optionally, such a model trainer may train machine-learned models based on a set of training data compiled from a plurality of different appliance models.

Remote server 310 includes a network interface such that interactive remote server 310 can connect to and communicate over one or more networks (e.g., network 302) with one or more network nodes. Network interface can be an onboard component or it can be a separate, off board component. In turn, remote server 310 can exchange data with one or more nodes over the network 302.

Although not pictured, it is understood that remote server 310 may further exchange data with any number of client devices over the network 302. The client devices can be any suitable type of computing device, such as a general purpose computer, special purpose computer, laptop, desktop, integrated circuit, mobile device, smartphone, tablet, or another suitable computing device. Information or signals (e.g., relating to component signals, data vectors of appliance performance, data matrices of appliance performance, analyzation results, machine-learned models, etc.) may thus be exchanged between domestic appliance 100 and various separate client devices through remote server 310.

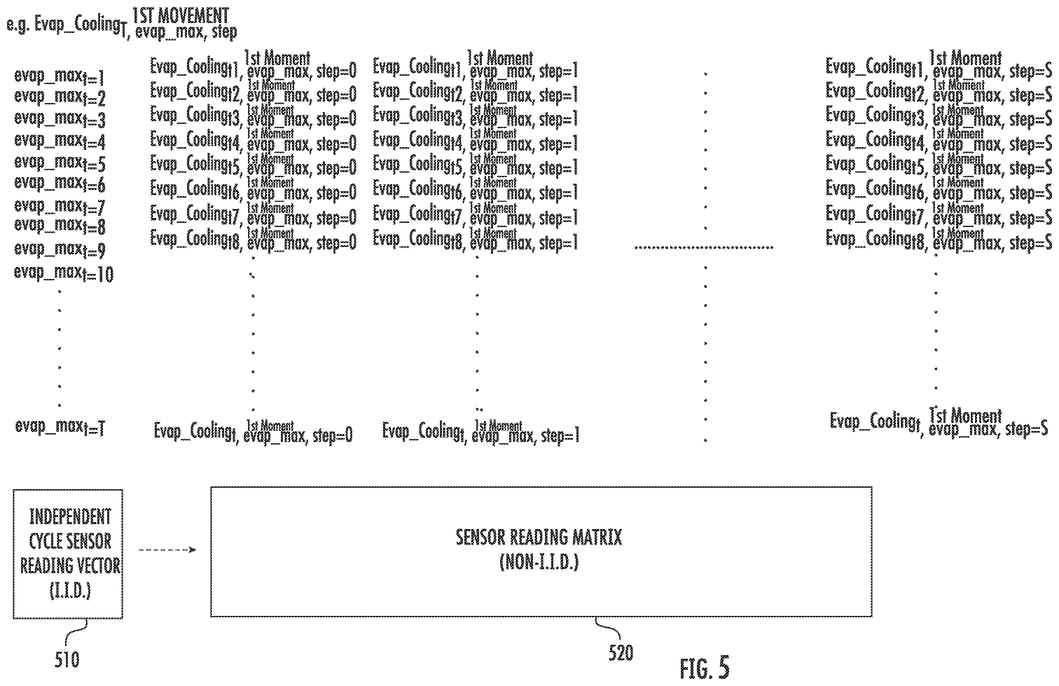

Turning now to FIGS. 5 through 8, during use of domestic appliance 100, controller 150 (FIG. 4) generally receives one or more component signals from a component (e.g., component B1 of subsystem B), which may be read and interpreted as one or more corresponding signal values (e.g., temperature at an evaporator 182, power usage at an evaporator fan 172, power usage at a compressor 170, etc.). The component signals may be, for instance, voltage signals received directly from the corresponding component or a sensor associated with the corresponding component (e.g., mounted to the component, such as a temperature sensor mounted to the evaporator 182). The signals, and thus values, may be received at regular intervals or cycles (e.g., a predefined period) of the corresponding subsystem (or appliance, generally). Optionally, a new cycle may be prompted or started according to a predetermined schedule (e.g., a predefined runtime period) or in response to a user action at the domestic appliance 100 (e.g., engaging the user interface or display 180). During use, each signal value may be timestamped (e.g., within controller 150) by cycle. Thus, the cycle in which the signal value is generated can be recorded. Optionally, one or more signals may be received for each cycle.

Once received, the signal values may be organized or used to construct an organized data set. For the purposes of illustration, an exemplary data set is provided below at Table 1. As illustrated, the organized data set may include multiple discrete data points, all organized according to the timestamp or cycle. Each data point be based on a received component signal. In particular, each data point may represent a raw signal value (e.g., detected temperature) received during the corresponding cycle or a function value based on the raw signal value(s) received during the corresponding cycle. For instance, data points may represent the result of a predetermined function applied to one or more raw signal values of the corresponding cycle. For instance, a formula may be used to calculate a mean value (e.g., cycle-specific average value, running average value, etc.), an extrema value (e.g., determining a maximum or minimum value of a cycle), or standard deviation value formula (e.g., determining a standard deviation of multiple values in a single cycle). In some embodiments, separate columns are provided for separate predetermined functions (e.g., a first predetermined function and a second predetermined function that is different from the first predetermined function).

TABLE 1

| Cycle [t] | Data Point 1 | Data Point 2 | . . . | Data Point X |
|---|---|---|---|---|
| 1 | DP1₁ | DP2₁ | . . . | DPXₜ₌₁ |
| 2 | DP1₂ | DP2₂ | . . . | DPXₜ₌₂ |
| . . . | . . . | . . . | . . . | . . . |
| t = T | DP1_{T} | DP2_{T} | . . . | DPX_{t=T} |

Each assembled data point column (e.g., DP1, DP2, DPX) may identify or provide a discrete corresponding vector that is organized (e.g., sequentially or descendingly, as shown) according to the cycles. Specifically, the discrete corresponding vector may be an independent and identically distributed (IID) vector, such as an independent cycle sensor reading vector 510 (FIG. 5). For instance, Data Point X may provide a data point vector of:

$$\vec{DPX} = [ \begin{matrix}D P {X}_{t = 1} \\ D P {X}_{t = 2} \\ ⋮ \\ D P {X}_{t = T}\end{matrix} ]$$

Using a single data point vector, a corresponding signal matrix may be generated. In particular, a recursive signal matrix (e.g., non-IID sensor reading matrix 520—FIG. 5) may be generated in which each step (5) (e.g., sequential column) of the matrix is influenced by a predetermined step number (e.g., 1, 3, 5, etc.) of previous vector values. For instance, a predetermined matrix function may be applied to the corresponding vector values. In some such embodiments, the predetermined matrix function is a moment formula (M) accounting for each recursive entry of the step number, such as a mean formula (e.g., running average of each recursive entry), an extrema value formula (e.g., determining a maximum or minimum value of the recursive entries), or standard deviation value formula (e.g., determining a standard deviation of the recursive entries). For instance, the vector of DPX may be used to generate the subsystem matrix wherein the step number is 1:

$$[ \begin{matrix}{SubSys}_{1 , 1 , 1}^{M} & {SubSys}_{1 , 1 , 2}^{M} & … & {SubSys}_{1 , 1 , S}^{M} \\ {SubSys}_{2 , 1 , 1}^{M} & {SubSys}_{2 , 1 , 2}^{M} & … & {SubSys}_{2 , 1 , S}^{M} \\ ⋮ & ⋮ & ⋱ & ⋮ \\ {SubSys}_{T , 1 , 1}^{M} & {SubSys}_{T , 1 , 2}^{M} & … & {SubSys}_{T , 1 , S}^{M}\end{matrix} ]$$

As would be understood in light of the present disclosure, each matrix entry (SubSys) could be the result of the moment formula applied to the corresponding vector entries. For instance, in the case of a running average moment formula applied to the vector of DPX, SubSys_{1,1,1}^{M}=DPXₜ₌₁. Moreover, SubSys_{1,1,2}^{M}=(DPXₜ₌₁+DPXₜ₌₂)/2.

As an additional or alternative example, an exemplary standard deviation formula may be applied as SubSys_{t,component,S}^{std}. Applied to a specific instance, the formula may thus be represented as

$${SubSys}_{3 , 7 , 4}^{std} = \sqrt{\begin{matrix}[ {( {DPX}_{3 , 7 , 0} - {DPX}_{3 , 7 , 0 \sim 3}^{mean} )}^{2} + {( {DPX}_{3 , 7 , 1} - {DPX}_{3 , 7 , 0 \sim 3}^{mean} )}^{2} + \\ {( {DPX}_{3 , 7 , 2} - {DPX}_{3 , 7 , 0 \sim 3}^{mean} )}^{2} + {( {DPX}_{3 , 7 , 3} - {DPX}_{3 , 7 , 0 \sim 3}^{mean} )}^{2} ] / 4\end{matrix}}$$

wherein the cycle number (t) is 3;

wherein the component is identified as “7” (i.e., “component #7 of the subsystem”); and

wherein the step number (5) is 4, which may be applied to a rolling window size of 3 (i.e., calculating the standard deviation of a rolling window size of 3 cycles). As illustrated above, calculated entries or values of may be recorded or organized in a descending order [e.g., a last in, first out (LIFO) order] for the generated matrix.

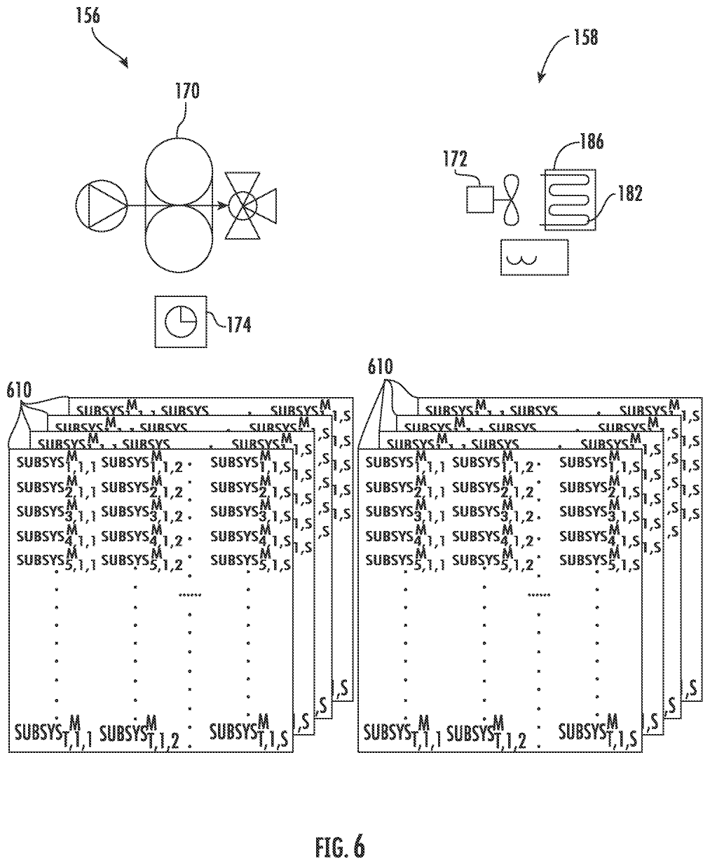

As illustrated in FIG. 6, for each subsystem (e.g., 156 and 158), multiple matrices 610 may be generated. For instance, each received data signal may be used to assemble one or more vectors, which in turn may be used to generate at least one signal matrix corresponding to each assembled vector. Optionally, one or more of the assembled vectors may each be used to generate one or more signal matrices (e.g., wherein each signal matrix is generated according to a different predetermined matrix function). Additionally or alternatively, geospatial (e.g., geographic or weather) data corresponding to the location in which the domestic appliance 100 is installed may be added to or included with one or more matrices.

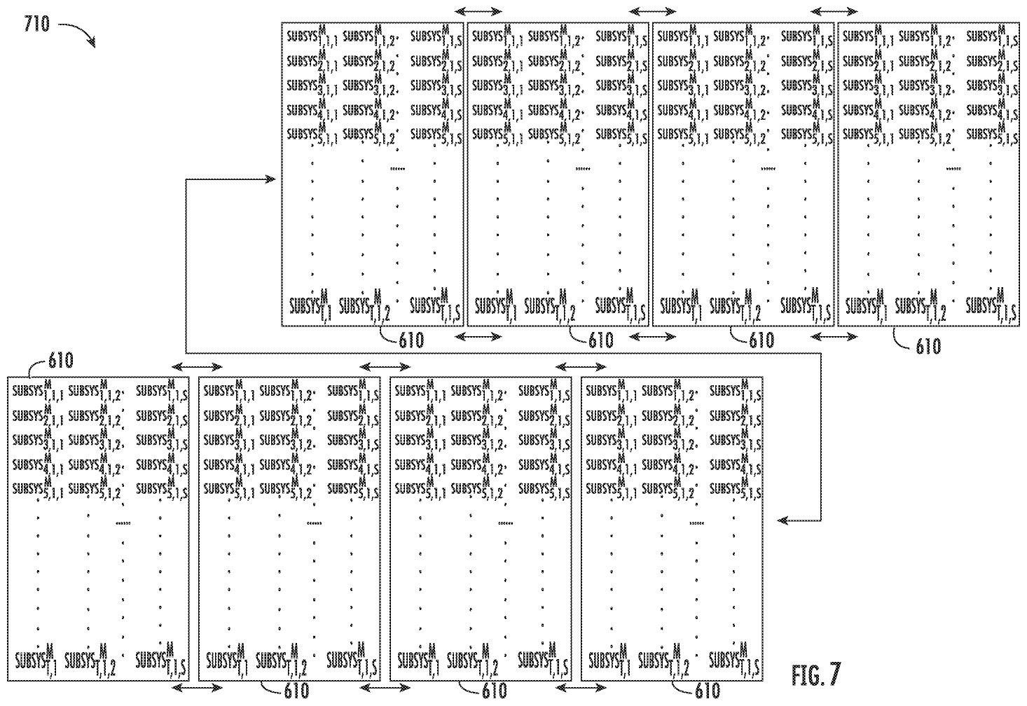

Once multiple matrices 610 are generated, the matrices 610 may be combined. In particular, the matrices 610 may be horizontally aligned (e.g., aligned or “stitched together” according to the cycles). The matrix entries for multiple components or subsystems may each be provided on the same row (i.e., cycle row). In turn, all of the first cycle entries may be provided on the same row as each other, all of the second cycle entries may be provided on the same row as each other (below or above the first cycle entry row), all of the third cycle entries may be provided on the same row as each other (below or above the second cycle entry row), and so on. Thus, a combined matrix 710 may be generated wherein each row is organized according to its corresponding cycle. Such a combination is illustrated in FIG. 7, wherein multiple matrices 610 of the same subsystem are combined before being combined with one or more matrices 610 of another separate subsystem. Advantageously, the combined matrix 710 (i.e., unified system matrix) may provide a single coherent portrait of appliance operation over time.

As shown in FIG. 8, the combined matrix 710 (FIG. 7) may be analyzed by one of the machine-learned models 810 (e.g., a single model). For instance, a machine vision or visual detection model at 810 may receive the combined matrix 710 and evaluate the entire combined matrix 710. Due to the advantageous composition of the combined matrix 710, the machine-learned model 810 may evaluate multiple aspects or anomalies of appliance performance at once. In other words, the machine-learned model 810 may output analyzation data (e.g., including one or more detected anomalies). For instance, it is notable that the likelihood for multiple potential failure points or anomalies of the domestic appliance 100 may be predicted simultaneously. Additionally or alternatively, it may be notable that various problems that may be manifested differently (e.g., to different degrees) at different portions of the domestic appliance 100 may be accurately predicted or identified (e.g., sooner than would be possible with existing models).

Referring now to FIG. 9, various methods (e.g., method 900) may be provided for use with system 300 in accordance with the present disclosure. In some embodiments, all or some of the various steps of the illustrated methods may be performed by one or more controllers (e.g., controller 150 or remote controller 350) as part of an operation that such controller(s) are configured to initiate for an appliance (e.g., a service operation for domestic appliance 100 that is executed independently of or as part of regular operation of the appliance, which may initiate operation in response to a user-initiated cycle or a predetermined triggering event during regular operation). Advantageously, a single portrait of performance for the domestic appliance 100 may be established. Additionally or alternatively, multiple aspects or anomalies (e.g., at different subsystems 156, 158 of appliance 100) may be predicted or tested for at the same time. Further additionally or alternatively, performance of domestic appliance 100 may be compared to the performance of multiple other appliances (e.g., of the same or different appliance makes and models).

FIG. 9 depicts steps performed in a particular order for the purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

At 910, the method 900 includes receiving one or more component signals of an appliance (e.g., domestic appliance). Specifically, the component signals may be received directly from an electronic component or from a sensor associated with the corresponding component (e.g., a sensor mounted to the corresponding component). In some embodiments, at least one component signal is received for each cycle of a plurality of discrete cycles. As would be understood in light of the present disclosure, a single cycle may be defined as predetermined period that follows or is followed by another cycle of appliance activation (i.e., runtime). Thus, each cycle may generally receive at least one component signal at a different point in time than the other cycles. As described above, one or more of the discrete cycles may be prompted according to a predetermined schedule. Additionally or alternatively, one or more of the discrete cycles may be prompted in response to a user action (e.g., at the domestic appliance).

Generally, the received component signals may correspond to at least one component of the appliance. In some embodiments, along with receiving a first plurality of component signals from one (e.g., first) component, a separate plurality of component signals may be received from one or more other (e.g., second, third, etc.) components. Nonetheless, the separate plurality of component signals may correspond to the same cycles as the first plurality of component signals. Thus, each component signal of the separate plurality of component signals may be generated at or received during the same cycle as at least one component signal of the first plurality of component signals.

At 920, the method 900 includes generating a plurality of discrete signal matrices based on the received component signals (e.g., as described above). In particular, a signal matrix may be generated based on (e.g., from) the received component signals of 910. For instance, from the received component signals, a corresponding vector may be assembled. The assembled vector may be organized (e.g., sequentially) according to the cycles, as described above. Additionally or alternatively, the assembled vector may be organized in descending order according to the cycles (e.g., such that the last/most-recent cycle is ordered on the top row, followed by the previous cycles therebelow; such as in a last in, first out order). Furthermore, from the assembled vector, one or more matrices may be generated. Optionally, a predetermined function (e.g., predetermined matrix function) may be used with the assembled vector to calculate a corresponding set of result values, which may then be assembled as a corresponding signal matrix having recursive entries of the result values (e.g., according to a set step number) for each cycle. Separate matrices may be generated from the same assembled vector. For instance, one signal matrix may be generated from the assembled vector using a first predetermined matrix function while another signal matrix is generated from the assembled vector using a second predetermined matrix function. As discussed above, the predetermined matrix function(s) may be or include a moment formula (e.g., mean formula, extrema value formula, standard deviation value formula, etc.).

If multiple pluralities of component signals are received, separate discrete matrices may be generated. For instance, at least one (e.g., first) matrix may be generated based on the first plurality of component signals. Moreover, at least one separate (e.g., second) matrix may generated based on a separate plurality of component signals. Thus, a first result values set may be calculated and assembled in a first signal matrix while a separate second result values set may be calculated and assembled in a second signal matrix.

At 930, the method 900 includes joining the plurality of discrete signal matrices as a combined matrix, as described above. For instance, multiple matrices may be stitched together or aligned by rows according to the plurality of discrete cycles. Thus, each row of the combined matrix may include multiple entries of values obtained at (e.g., corresponding to) the same cycle.

Prior to or subsequent to stitching or aligning the rows, the data within the signal matrices or combined matrix may be cleansed or standardized. For instance, it is possible that the signal matrices may initially include data that differs between the matrices in terms of range or measurement units. Thus, the data of the combined matrix may need to be standardized to distribute all of the data entries within a uniform range or units, as would be understood.

At 940, the method 900 includes analyzing the combined matrix (e.g., following standardization of the data within the combined matrix) for appliance performance. For instance, the combined matrix may be evaluated according to a machine-learned model (e.g., locally on the domestic appliance or on a remote server). In some embodiments, one or more anomalies in the domestic appliance (e.g., relating to performance of the domestic appliance) may be identified based on the evaluation of the machine learned model. The anomalies may include inappropriate performance of a component, component failure, potential fluid leak(s), component wear, or another condition of the domestic appliance that warrants attention from a user or service person.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a domestic appliance comprising a first component and a second component, the method comprising:
receiving a plurality of first component signals from the first component over a plurality of discrete cycles;
generating a first signal matrix based on the received plurality of first component signals;
receiving a plurality of second component signals from the second component over the plurality of discrete cycles;
generating a second signal matrix based on the received plurality of second component signals;
joining the first signal matrix and the second signal matrix together as a combined matrix; and
analyzing the combined matrix for appliance performance.

2. The method of claim 1, wherein the plurality of discrete cycles are prompted according to a predetermined schedule.

3. The method of claim 1, wherein the plurality of discrete cycles are prompted in response to a user action at the domestic appliance.

4. The method of claim 1, wherein the plurality of first component signals are received directly from the first component.

5. The method of claim 1, wherein the plurality of first component signals are received from a sensor associated with the first component.

6. The method of claim 1, wherein generating the first signal matrix comprises assembling the received first component signals as a first vector, and wherein the first signal matrix is generated from the first vector.

7. The method of claim 6, wherein generating the first signal matrix comprises
calculating a first set of result values of a predetermined matrix function using the first vector, and
assembling the first set of result values in the first signal matrix as a recursive matrix comprising recursive entries of result values of the first set.

8. The method of claim 7, wherein the predetermined matrix function comprises a moment formula.

9. The method of claim 7, wherein generating the second signal matrix comprises
assembling the received second component signals as a second vector,
calculating a second set of result values of the predetermined matrix function using the second vector, and
assembling the second set of result values in the second signal matrix as a recursive matrix comprising recursive entries of result values of the second set for each cycle of the plurality of discrete cycles.

10. The method of claim 9, wherein joining the first signal matrix and the second signal matrix comprises aligning rows of the matrices according to the plurality of discrete cycles.

11. The method of claim 1, wherein analyzing the combined matrix comprises evaluating the combined matrix according to a machine-learned model.

12. A method of operating a domestic appliance comprising a first component, the method comprising:
receiving a plurality of first component signals from the first component over a plurality of discrete cycles;
generating a first signal matrix based on the received plurality of first component signals, generating the first signal matrix comprising
assembling the received first component signals as a vector,
calculating a first set of result values of a first predetermined matrix function using the vector, and
assembling the first set of result values in the first signal matrix as a recursive matrix comprising recursive entries of result values of the first set for each cycle of the plurality of discrete cycles;
generating a second signal matrix based on the received plurality of first component signals, generating the second signal matrix comprising
calculating a second set of result values of a second predetermined matrix function using the vector, and
assembling the second set of result values in the second signal matrix as a recursive matrix comprising recursive entries of result values of the second set for each cycle of the plurality of discrete cycles;
joining the first signal matrix and the second signal matrix together as a combined matrix; and
analyzing the combined matrix for appliance performance.

13. The method of claim 12, wherein the plurality of discrete cycles are prompted according to a predetermined schedule.

14. The method of claim 12, wherein the plurality of discrete cycles are prompted in response to a user action at the domestic appliance.

15. The method of claim 12, wherein the plurality of first component signals are received directly from the first component.

16. The method of claim 12, wherein the plurality of first component signals are received from a sensor associated with the first component.

17. The method of claim 12, wherein the first predetermined matrix function comprises a moment formula, and wherein the second predetermined matrix function is different from the first predetermined matrix function and comprises a moment formula.

18. The method of claim 12, wherein joining the first signal matrix and the second signal matrix comprises aligning rows of the matrices according to the plurality of discrete cycles.

19. The method of claim 12, wherein analyzing the combined matrix comprises evaluating the combined matrix according to a machine-learned model.

20. A method of operating an electronic assembly, the method comprising:
receiving one or more component input signals vectors of the electronic assembly;
generating a plurality of discrete signal matrices based on the one or more input signals;
joining the plurality of discrete signal matrices together as a combined matrix; and
analyzing the combined matrix for appliance performance.
